(19) United States
(12) Patent Application Publication
(10) Pub. No.: US 2026/0017385 A1
(43) Pub. Date: Jan. 15, 2026

(54) Method For Detecting Vulnerabilities In A Program

(71) Applicant: Labrador Labs, Inc, Seoul (KR)

(72) Inventors: Young Mi SHIN, Gyeonggi-do (KR); Young Hwan LEE, Seoul (KR)

(73) Assignee: Labrador Labs, Inc, Seoul (KR)

(21) Appl. No.: 19/257,186

(22) Filed: Jul. 1, 2025

(30) Foreign Application Priority Data
Jul. 12, 2024 (KR) 10-2024-0092172

(51) Int. Cl. G06F 21/57; G06F 21/56

(52) U.S. Cl. CPC G06F 21/577; G06F 21/565

(57) ABSTRACT

According to an embodiment of the present disclosure, a method for detecting vulnerability in program containing a plurality of source code files, performed by a computing device is disclosed. The method may comprises: extracting at least one of a vulnerability file name corresponding to a pre-stored vulnerability file or a vulnerability function name corresponding to a pre-stored vulnerability function, from a description of pre-stored vulnerabilities; extracting at least one candidate source code file from among the plurality of source code files in the program, the candidate source code file being subject to determination of whether it contains a vulnerability; and determining at least one of a target file or a target function having a vulnerability within the program, by using the candidate source code file and at least one of the vulnerability file name or the vulnerability function name.

### CROSS-REFERENCE TO RELATED APPLICATIONS

This application claims priority to and the benefit of Korean Patent Application No. 10-2024-0092172 filed in the Korean Intellectual Property Office on Jul. 12, 2024, the entire contents of which are incorporated herein by reference.

### TECHNICAL FIELD

The present disclosure relates to a software field, and more particularly, to a method for detecting vulnerabilities in a software program.

### BACKGROUND ART

With the development of a software field, many open sources are being disclosed today, and an open source may refer to software in which source codes are disclosed and can be freely used, modified, and distributed.

Using the open source can have an effect that companies can reduce software development costs and time, and developers can benefit from improving the quality of software by complementing vulnerabilities or shortcomings of the open source through cooperation.

Such an open source may contain vulnerabilities such as security or bugs. Thus, a Common Vulnerabilities and Exposures (CVE) system for managing the vulnerabilities of the open source may coexist with the open source.

The CVE easily finds vulnerabilities and shares information about the vulnerabilities through CVE numbers for identifying and managing vulnerabilities.

Enterprises and software developers can secure information about vulnerabilities based on CVE, respond appropriately to the vulnerabilities, and quickly develop security updates and patches.

However, technique of securing vulnerability information using such CVE has a limitation in that a file and a function corresponding to a vulnerability cannot be specified. In addition, many resources are being used in the process of passively finding vulnerabilities to programs using such CVE by developers.

### SUMMARY OF THE INVENTION

The present disclosure is contrived in response to the foregoing background art, and is intended to efficiently detect a vulnerability in a program including a plurality of source code files.

Technical objects of the present disclosure are not restricted to the technical object mentioned above. Other unmentioned technical objects will be apparently appreciated by those skilled in the art by referencing the following description.

According to an embodiment of the present disclosure, a method for detecting vulnerability in program containing a plurality of source code files, performed by a computing device is disclosed. The method may comprises: extracting at least one of a vulnerability file name corresponding to a pre-stored vulnerability file or a vulnerability function name corresponding to a pre-stored vulnerability function, from a description of pre-stored vulnerabilities; extracting at least one candidate source code file from among the plurality of source code files in the program, the candidate source code file being subject to determination of whether it contains a vulnerability; and determining at least one of a target file or a target function having a vulnerability within the program, by using the candidate source code file and at least one of the vulnerability file name or the vulnerability function name.

In one embodiment, the extracting at least one of the vulnerability file name or the vulnerability function name comprises: tokenizing a sentence included in the description into a plurality of words and identifying a part of speech of each of the tokenized words to extract at least one noun, thereby determining the noun as the vulnerability file name or the vulnerability function name.

In one embodiment, the determining the noun as the vulnerability file name or the vulnerability function name comprises: determining the noun as the vulnerability file name when the noun includes a predefined first character string, or determining the noun as the vulnerability function name when the noun includes a predefined second character string, wherein the first character string and the second character string are different character strings from each other.

In one embodiment, the determining at least one of the target file or the target function comprises: when the vulnerability function name is not extracted and the vulnerability file name is extracted in the extracting at least one of the vulnerability file name or the vulnerability function name, determining whether at least one candidate source code file is the target file by using the extracted vulnerability file name.

In one embodiment, the determining whether at least one candidate source code file is the target file by using the extracted vulnerability file name comprises: determining whether the vulnerability file name and a name of the candidate source code file match; determining the candidate source code file as the target file when the vulnerability file name and the name of the candidate source code file match; and repeatedly performing the determining at least one of a target file or a target function having a vulnerability within the program, by using the name of the candidate source code file and at least one of the vulnerability file name or the vulnerability function name, when the vulnerability file name and the name of the candidate source code file do not match.

In one embodiment, the determining at least one of the target file or the target function comprises: determining whether the number of the candidate source code files within the program is one, when the vulnerability function name is not obtained and the vulnerability file name is not obtained; determining the candidate source code file as the target file, when the number of the candidate source code files is one; and repeatedly performing the determining at least one of a target file or a target function having a vulnerability within the program, by using a name of the candidate source code file and at least one of the vulnerability file name or the vulnerability function name, when the number of the candidate source code files is not one.

In one embodiment, the determining at least one of a target file or a target function having a vulnerability within the program, by using a name of the candidate source code file and at least one of the vulnerability file name or the vulnerability function name comprises: determining whether a candidate function is included in the candidate source code file, when the vulnerability function name is obtained; and determining the target function by using a name of the candidate function, when it is determined that the candidate function is included in the candidate source code file.

In one embodiment, the determining the target function by using the name of the candidate function comprises: determining whether the vulnerability function name and the name of the candidate function match; and determining the candidate function as the target function and determining the candidate source code file including the candidate function as the target file, when it is determined that the vulnerability function name and the name of the candidate function match.

In one embodiment, the determining at least one of the target file or the target function comprises: determining whether the vulnerability function name and the name of the candidate function match; when it is determined that the vulnerability function name and the name of the candidate function do not match, determining whether the vulnerability file name is obtained, when it is determined that the vulnerability function name and the name of the candidate function do not match; and determining the target file based on whether the vulnerability file name is obtained, or determining the target file based on the number of the candidate source code files.

In one embodiment, the extracting the at least one candidate source code file comprises: determining whether a candidate function is included in the candidate source code file when the vulnerability function name is obtained, and the determining at least one of the target file or the target function comprises: determining whether the vulnerability file name is obtained, when it is determined that the candidate function is not included in the candidate source code file; and determining the target file based on whether the vulnerability file name is obtained, or determining the target file based on the number of the candidate source code files.

In one embodiment, the candidate source code file is a file including a modified portion within the program.

In one embodiment, a non-transitory computer readable storage medium including a computer program is disclosed. The computer program causes a computing device to perform a method for detecting vulnerability in a program containing a plurality of source code files, wherein the method comprises: extracting at least one of a vulnerability file name corresponding to a pre-stored vulnerability file or a vulnerability function name corresponding to a pre-stored vulnerability function, from a description of pre-stored vulnerabilities; extracting at least one candidate source code file from among the plurality of source code files in the program, the candidate source code file being subject to determination of whether it contains a vulnerability; and determining at least one of a target file or a target function having a vulnerability within the program, by using the candidate source code file and at least one of the vulnerability file name or the vulnerability function name.

In one embodiment, computing device detecting vulnerability in program containing a plurality of source code files is disclosed. The computing device comprises at least one processor; and a memory; and wherein the at least one processor performs: extracting at least one of a vulnerability file name corresponding to a pre-stored vulnerability file or a vulnerability function name corresponding to a pre-stored vulnerability function, from a description of pre-stored vulnerabilities; extracting at least one candidate source code file from among the plurality of source code files in the program, the candidate source code file being subject to determination of whether it contains a vulnerability; and determining at least one of a target file or a target function having a vulnerability within the program, by using the candidate source code file and at least one of the vulnerability file name or the vulnerability function name.

A technique according to one embodiment of the present disclosure may generate an effect of efficiently detecting a vulnerability in a program including a plurality of source code files.

Effects which can be acquired in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following embodiments, for purposes of explanation, numerous specific details are set forth to provide a comprehensive understanding of one or more aspects. However, it will be apparent that the aspect(s) can be executed without the detailed matters.

FIG. 1 is a schematic diagram of a computing device for detecting vulnerabilities in a program including a plurality of source code files according to one embodiment of the present disclosure.

FIG. 2 is a flowchart illustrating a method for detecting vulnerabilities in a program including a plurality of source code files according to one embodiment of the present disclosure.

FIG. 3 is a diagram illustrating an example of a method for detecting vulnerabilities in a program including a plurality of source code files according to one embodiment of the present disclosure.

FIG. 4 is another flowchart illustrating a specific method for detecting vulnerabilities in a program including a plurality of source code files according to one embodiment of the present disclosure.

FIG. 5 illustrates a simple and general schematic view of an exemplary computing environment in which the embodiments of the present disclosure may be implemented.

### DETAILED DESCRIPTION

Various embodiments will now be described with reference to drawings. In the present specification, various descriptions are presented to provide appreciation of the present disclosure. However, it is apparent that the embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

Moreover, the term “or” is intended to mean not exclusive “or” but inclusive “or”. That is, when not separately specified or not clear in terms of a context, a sentence “X uses A or B” is intended to mean one of the natural inclusive replacements. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

Further, it should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

In addition, the term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the embodiments disclosed herein may be additionally implemented as electronic hardware, computer software, or combinations of both sides.

The description of the presented embodiments is provided so that those skilled in the art of the present disclosure use or implement the present disclosure. Various modifications to the embodiments will be apparent to those skilled in the art. Generic principles defined herein may be applied to other embodiments without departing from the scope of the present disclosure. Therefore, the present disclosure is not limited to the embodiments presented herein. The present disclosure should be analyzed within the widest range which is coherent with the principles and new features presented herein.

Terms expressed as N-th such as first, second, or third in the present disclosure are used to distinguish at least one entity. For example, entities expressed as first and second may be the same as or different from each other.

A program in the present disclosure may be a collection (aggregate) of a series of instructions that perform a specific task executed on a device. For example, the program may be a source code or a collection of source codes of software written in a programming language. As an example, the program may indicate an object to which a vulnerability detection technique according to one embodiment of the present disclosure is applied. Software and a program in the present disclosure may be used interchangeably with each other.

The source code in the present disclosure may be a design diagram used in software production. For example, the source code may be instructions (text) and/or a set of instructions (texts) written in the programming language. A functionality of the program may be implemented on a computing device as such source code is executed by a processor.

A file and/or a source code file in the present disclosure may be a text-format file including the source code. For example, the program may be a collection of a plurality of files including the source code.

A function in the present disclosure may be a set of instructions for a specific operation. For example, a function may include instructions written by a user to perform a specific operation, and may include a function name defined by the user.

The program in the present disclosure may include at least one source code file. In addition, the source code file may or may not include a function.

In one embodiment, when the source code file includes at least one function, the program includes at least one source code file, and the at least one source code file may be a structure including at least one function. In other words, the function may be included in the source code file, and the source code file may be included in or correspond to the program.

For example, the program includes one source code file, and the one source code file may include at least one function or may not include a function. As another example, the program includes a plurality of source code files, and each of the plurality of source code files may include at least one function or may not include a function.

In the present disclosure, an open source may mean a source code that is freely available online or the like for anyone to use. For example, a user of the open source may redistribute the open source using the open source and may modify and use the source code in the process of using the open source.

Vulnerabilities in the present disclosure may mean defects or weaknesses in the source code, and the open source may include a source code maliciously included by a user, and the like. For example, the vulnerabilities may cause information security and system exposure, etc., at the device through the program.

In one embodiment, the vulnerabilities in the source code may mean defects or errors in the code that may cause problems with the functionality, security, and performance of the program. The vulnerabilities may be exploited by hackers and the like, and may cause various security problems such as sensitive information leakage, data tampering, denial of service (DOS) attacks, and the like. Representative source code vulnerability types include buffer overflow, SQL injection, cross-site scripting, cross-site request forgery, hardcoded passwords, and/or weak encryption.

In one embodiment, the vulnerabilities may be managed via a previously stored vulnerability management system. For example, the vulnerability management system may assign an identification factor to each vulnerability, determine the vulnerability with a description corresponding to each vulnerability, and include a description of a problem prevention or solution corresponding to the vulnerability.

In one embodiment, the vulnerability identification factor may be a file name of a source code file corresponding to the vulnerability or a function name of a function included in the source code corresponding to the vulnerability.

In one embodiment, the vulnerability management system may include a text-type description corresponding to the vulnerabilities. For example, the description may include vulnerability identification factors, and include sentences that describe problems and solutions corresponding to the vulnerability identifiers, and the like.

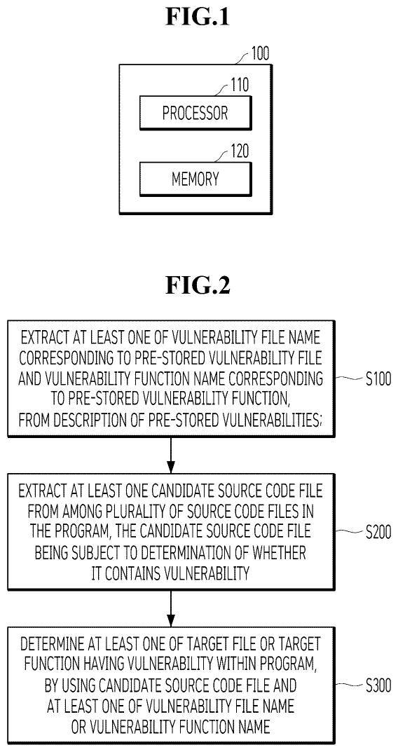

FIG. 1 is a schematic diagram of a computing device for detecting vulnerabilities in a program including a plurality of source code files according to one embodiment of the present disclosure.

Referring to FIG. 1, a computing device 100 may include a processor 110 including at least one core and a memory 120 storing a computer program executable by the processor 110.

A configuration of the computing device 100 illustrated in FIG. 1 is only a simplified example. In one embodiment of the present disclosure, the computing device 100 may include other components for performing the computing environment of the computing device 100, and only some of the disclosed components may constitute the computing device 100.

In one embodiment, the processor 110 may be constituted by at least one core, and may include processors for data analysis and/or processing, which include a central processing unit (CPU), a general purpose graphics processing unit (GPGPU), a tensor processing unit (TPU), and the like of the computing device 100.

In one embodiment, the processor 110 may read a computer program stored in the memory 120 to perform methodologies for detecting a vulnerability according to one embodiment of the present disclosure.

Additionally, the processor 110 may generally process an overall operation of the computing device 100. For example, the processor 110 may perform a task of providing a user with or processing appropriate information or functionality by processing data, information, or signals input or output via components included in the computing device 100, or driving an application program stored in the memory 120.

In one embodiment, any type of information generated or determined by the processor 110 and any type of information received by the computing device 100 may be stored in the memory 120. According to one embodiment of the present disclosure, the memory 120 may be a storage medium storing computer software allowing the processor 110 to perform the operations according to the embodiments of the present disclosure. Therefore, the memory 120 may mean computer-readable media for storing software codes required for performing the embodiments of the present disclosure, data which become execution targets of the codes, source code files, and execution results of the codes.

In one embodiment, the memory 120 may mean any type of storage medium. For example, the memory 120 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 120 on the Internet. The aforementioned description of the memory is just an example and the memory 120 used in the present disclosure is not limited to the aforementioned examples.

In one embodiment, the computing device 100 may further include a server (not illustrated) and/or a communicable network unit (not illustrated). The network unit may be configured regardless of communication modes such as wired and wireless modes and constituted by various communication networks including a personal area network (PAN), a wide area network (WAN), and the like. Further, the network unit 150 may operate based on World Wide Web (WWW) and may adopt a wireless transmission technology used for short-distance communication, such as infrared data association (IrDA) or Bluetooth.

In one embodiment, the computing device 100 may perform steps for detecting vulnerabilities in a program that includes a plurality of source code files.

A specific example in which the computing device 100 performs steps for detecting the vulnerabilities in the program that includes the plurality of source code files is described with reference to the following drawings.

FIG. 2 is a flowchart illustrating a method for detecting vulnerabilities in a program including a plurality of source code files according to one embodiment of the present disclosure.

Referring to FIG. 2, a method for detecting vulnerabilities in a program including a plurality of source code files performed by the computing device 100 is disclosed.

In one embodiment, in S100, the computing device 100 may extract at least one of a vulnerability file name corresponding to a pre-stored vulnerability file and a vulnerability function name corresponding to a pre-stored vulnerability function from a description of pre-stored vulnerabilities.

In one embodiment, the description of the pre-stored vulnerabilities may be data stored in the memory 120 of the computing device 100 and/or a separate device (not illustrated). In one embodiment, the description may be data which the computing device 100 acquires by accessing an external device.

In one embodiment, the description may be text (e.g., sentence) data describing vulnerabilities included in an open source.

In one embodiment, the description may be a sentence including a description of vulnerabilities included in a vulnerability management system, and each of the vulnerabilities may include an identification factor (file name or function name).

In one embodiment, the computing device 100 may extract a vulnerability file name, and may extract one or a plurality of vulnerability file names.

In one embodiment, the computing device 100 may extract a vulnerability function name, and may extract one or a plurality of vulnerability function names.

In one embodiment, a vulnerability file and a vulnerability function are separate or the vulnerability function may be a function included in the vulnerability file.

In one embodiment, the vulnerability function name may correspond to a function included in a file corresponding to the vulnerability file name.

In one embodiment, the computing device 100 may extract one vulnerability file name and one vulnerability function name, or may extract one vulnerability files name and a plurality of vulnerability function names.

In one embodiment, the computing device 100 may extract the plurality of vulnerability file names, and may extract one or the plurality of vulnerability function names.

In one embodiment, the computing device 100 may tokenize sentences included in the description to determine a part of speech for each of the tokenized sentences, and determine words which satisfy conditions corresponding to a predefined file name and a predefined function name among words corresponding to nouns, as a vulnerability file name and vulnerability function name, respectively. For example, the computing device 100 may determine a word including a character string “.” and/or “.c” as the vulnerability file name and determine a word including the character string “_” and/or “( )” as the vulnerability function name, among words corresponding to nouns. The character strings for determining the vulnerability file name and the vulnerability function name are not limited to the listed examples, and may be freely changed in design by the user based on the file names and the function names used in the field.

In one embodiment, in S200, the computing device 100 may extract, from the program, at least one candidate source code file from the plurality of source code files to determine whether a vulnerability is included.

In one embodiment, the program may include one source code file or a plurality of source code files. In one embodiment, the candidate source code file may be a source code file with a changed content among the source code files in the program. For example, the candidate source code file may be a source code file, among the source code files, in which a commit is performed to introduce a patch for modifying a bug or adding a new function, and/or a source code file on which an operation of applying the patch to a project and committing a result change is performed.

In one embodiment, in S300, the computing device 100 may determine at least one of a target file and a target function having a vulnerability in the program by using at least one of the vulnerability file name and the vulnerability function name and the candidate source code file.

In one embodiment, the target file may be a source code file that the computing device 100 determines to contain the vulnerability.

In one embodiment, the target function may be a function determined to contain the vulnerability by the computing device 100 within the source code file.

In one embodiment, the target function may be included in the target file, and when the target function is determined by the computing device 100, a source code file including the target function may be determined as the target file.

In one embodiment, the computing device 100 may obtain the name of the file from a table of contents including the name of at least one file included in the program, and obtain, as the name of the function, an instruction including a predetermined character string among instructions included in the source code. For example, the character string corresponding to the name of the function may be the same as the character string that determines the vulnerability function name.

In one embodiment, a specific method in which the computing device 100 determines at least one of the target file and the target function having the vulnerability in the program by using at least one of the vulnerability file name and the vulnerability function name and the candidate source code file will be described with reference to the following drawings.

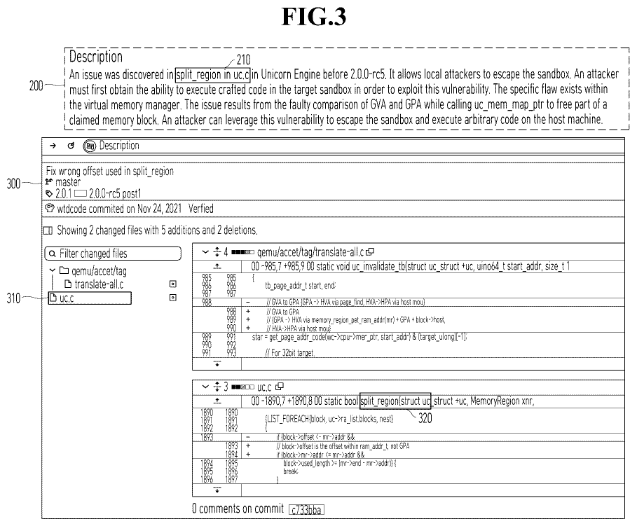

FIG. 3 is a diagram illustrating an example of a method for detecting vulnerabilities in a program including a plurality of source code files according to one embodiment of the present disclosure.

Referring to FIG. 3, a description 200 and a program 300 for describing vulnerabilities included in an open source are disclosed.

In one embodiment, the computing device 100 may extract at least one of a vulnerability file name and the vulnerability function name from the description 200.

In one embodiment, the computing device 100 may tokenize a sentence included in the description 200 into a plurality of words, and identify a part of speech of each of the tokenized words to extract at least one noun, thereby determining the noun as the vulnerability file name or the vulnerability function name.

For example, as a methodology for identifying the part of speech of each of the tokenized words, a rule-based approach may be considered. The rule-based approach may identify a part of speech for each of the input tokens by using a grammatical rule and a lexical dictionary. The grammatical rule herein may be used to identify a specific part of speech in a specific context, and the lexical dictionary may be used to identify information on a part of speech available for a word corresponding to a specific token.

For example, as the methodology for identifying the part of speech of each of the tokenized words, a machine learning-based approach may be considered. The machine learning-based approach may utilize a scheme of training a part of speech tagging model (e.g., a noun tagging model) based on supervised learning using training data. Labeled corpus may be prepared in advance for supervised learning. Algorithms used in such machine learning-based approach may include a naive Bayes classifier, a conditional random field, and/or a support vector machine. Such a machine learning-based approach may extract features of each token and surrounding tokens in an input token or set of tokens by utilizing a feature extraction model. The machine learning-based approach may input the extracted feature into the part of speech tagging model and obtain a result of predicting the part of speech (e.g., noun) corresponding to the feature from the part of speech tagging model.

For example, as the methodology for identifying the part of speech of each of the tokenized words, a neural network-based approach may be considered. The neural network-based approach may be implemented using a recurrent neural network model (RNN), a long short-term memory network (LSTM), and/or a transformer-based model(s). By transforming a token or a set of tokens into an embedding vector and inputting the embedding vector into a model, a prediction result of a part of speech corresponding to the token or a prediction result as to whether the token is the noun may be obtained.

In one embodiment, the computing device 100 may determine the vulnerability file name and the vulnerability function name based on a predefined character string among the extracted nouns.

In one embodiment, the computing device 100 may pre-store a first character string included in a file name and a second character string included in a function name. For example, the first character string and the second character string may be specific alphabets, special characters, numbers, or the like, and the first character string and the second character string may be different from each other.

In one embodiment, the computing device 100 may determine the extracted noun as the vulnerability file name when the extracted noun includes a predefined first character string. For example, the first character string may be “.c” or “.”.

In one embodiment, the computing device 100 may determine the extracted noun as the vulnerability function name when the extracted noun includes a predefined second character string. For example, the second character string may be “_”.

In one embodiment, the tokenized extracted nouns may include “split_region in uc.c” 210, and the computing device 100 may determine “split_locality” as the vulnerability function name and “uc.c” as the vulnerability file name in the “split_area in uc.d” 210.

In one embodiment, the computing device 100 may scan characters and/or words in the program 300 to obtain a function name and/or a file name.

In one embodiment, the computing device 100 may determine, as a target file 310, a file having the same file name as the vulnerability file name “uc.c” among the files included in the program 300.

In one embodiment, the computing device 100 may determine, as a target function 320, a function having the same function name as the vulnerability function name “split_region” among the functions included in the program 300.

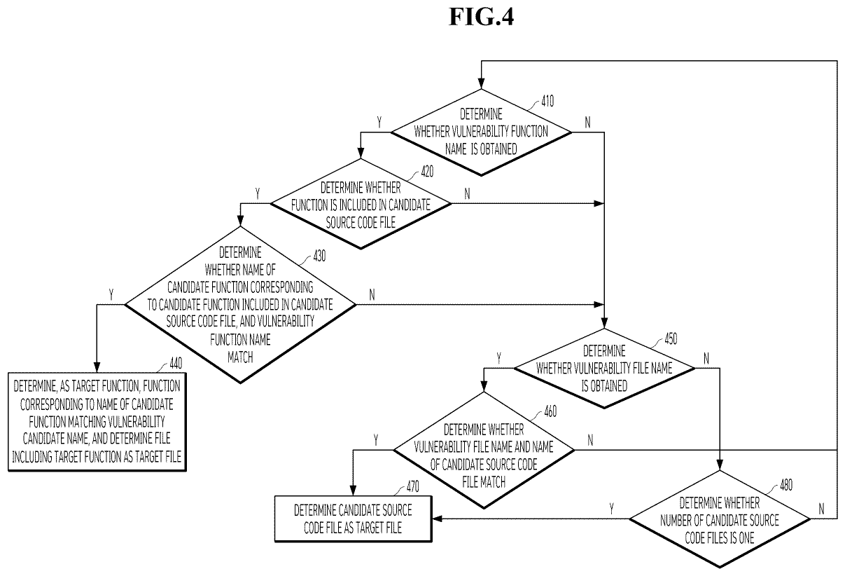

FIG. 4 is another flowchart illustrating a specific method for detecting vulnerabilities in a program including a plurality of source code files according to one embodiment of the present disclosure.

Referring to FIG. 4, the computing device 100 may determine at least one of a target file and a target function having a vulnerability in the program by using at least one of the vulnerability file name and the vulnerability function name and the candidate source code file.

In one embodiment, the computing device 100 may extract the vulnerability file name and/or the vulnerability function name, and extract a candidate source code file.

In one embodiment, in 410, the computing device 100 may determine with reference to FIG. 3, whether the vulnerability function name is extracted from the description 200.

For example, the description 200 may not include the vulnerability function name, and as a result, the computing device 100 may not extract the vulnerability function name.

In one embodiment, when it is determined in 410 that the vulnerability function name is obtained from the description 200, in 420, the computing device 100 may determine whether a function is included in the candidate source code file, and when the function is included, the computing device 100 may determine whether the function is a candidate function.

In one embodiment, the candidate function may be a function in a candidate source code file corresponding to a case where a word and/or a sentence such as an instruction in the function is changed and/or the function itself is added.

In one embodiment, when it is determined that the function is included in the candidate source code file and that the function is the candidate function, the computing device 100 may determine a target function corresponding to the vulnerability by using a name of the candidate function. For example, there may be a plurality of candidate source code files.

In one embodiment, the computing device 100 may determine, in 430, whether the name of the candidate function matches a previously extracted vulnerability function name.

In one embodiment, the computing device 100 may extract a plurality of vulnerability function names and names of a plurality of candidate functions.

When a plurality of vulnerability function names and a plurality of candidate function names are extracted, the computing device 100 may compare the plurality of vulnerability function names and the plurality of candidate function names one-to-one, and check whether the plurality of vulnerability function names and the plurality of candidate function names match.

In one embodiment, in 440, the computing device 100 may determine, as the target function, at least one candidate function whose name is determined to match the vulnerability function name among the candidate functions.

In one embodiment, there may be one candidate source code file, and a plurality of candidate functions may be extracted from one candidate source code file.

In one embodiment, there may be a plurality of candidate source code files, and a plurality of candidate functions may be extracted from the plurality of candidate source code files.

In one embodiment, when the target function is determined, the computing device 100 may determine, as the target file, a candidate source code file including the target function.

In one embodiment, in 430, the computing device 100 may determine that the vulnerability function name and the name of the candidate function do not match.

In one embodiment, in 440, the computing device 100 may determine whether the vulnerability file name is obtained from the description 200 when it is determined that the vulnerability function name and the name of the candidate function do not match.

In one embodiment, the computing device 100 may determine the target file based on whether the vulnerability file name is obtained. Alternatively, the computing device 100 may determine the target file based on the number of candidate source code files.

In one embodiment, when the vulnerability function name is not extracted and the vulnerability file name is extracted in a step of extracting at least one of the vulnerability file name and the vulnerability function name, the computing device 100 may determine whether the at least one candidate source code file is the target file by using the extracted vulnerability file name.

In one embodiment, in 460, the computing device 100 may determine whether the vulnerability function name and the name of the candidate source code file match.

In one embodiment, when the vulnerability file name and the name of the candidate source code file match, the computing device 100 may determine the candidate source code file as the target file in 470.

In one embodiment, when it is determined in 460 that the vulnerability file name and the name of the candidate source code file do not match each other, the computing device 100 may repeatedly perform a step of determining at least one of the target file and the target function having the vulnerability within the program by using at least one of the vulnerability file name and the vulnerability function name and the name of the candidate source code file.

In one embodiment, when it is determined in 460 that the vulnerability file name and the name of the candidate source code file do not match, the computing device 100 may return to 410 and re-perform the step of determining whether the vulnerability function name is obtained.

In one embodiment, the computing device 100 may determine in 480 whether the number of candidate source code files extracted from the program 300 is one when it is determined in 410 that the vulnerability function name is not obtained, and it is determined in 450 that the vulnerability file name is not obtained.

In one embodiment, when it is determined in 480 that the number of candidate source code files is one, the computing device 100 may determine the candidate source code file as the target file.

In one embodiment, when it is determined in 480 that the number of candidate source code files is not one, the computing device 100 may repeatedly perform the step of determining at least one of the target file and the target function having the vulnerability within the program by using at least one of the vulnerability file name and the vulnerability function name and the name of the candidate source code file.

In one embodiment, when it is determined in 480 that the number of candidate source code files is not one, the computing device 100 may return to 410 and re-perform the step of determining whether the vulnerability function name is obtained.

In one embodiment, when it is determined in 410 that the vulnerability function name is obtained, the computing device 100 may determine in 420 whether the candidate function is included in the candidate source code file.

In one embodiment, when it is determined in 420 that the candidate function is not included in the candidate source code file, the computing device 100 may determine in 450 whether the vulnerability file name is obtained.

In one embodiment, when it is determined in 450 that the vulnerability file name is obtained, the computing device 100 may determine in 460 whether the vulnerability file name and the name of the candidate source code file match.

For example, when the vulnerability file name and the name of the candidate source code file match, the computing device 100 may determine the candidate source code file as the target file.

In one embodiment, when it is determined in 450 that the vulnerability file name is not obtained, the computing device 100 may determine the target file based on the number of candidate source code files.

According to the embodiments of the present disclosure, the computing device 100 determines only a specific file and/or a specific function corresponding to the vulnerability as the vulnerability from the description including the vulnerability patch information, thereby obtaining an effect of determining a specific and accurate vulnerability location (specific file and/or function including the vulnerability) and a content of the vulnerability, unlike the past determination that the vulnerability exists for all files in a program determined to include the vulnerability.

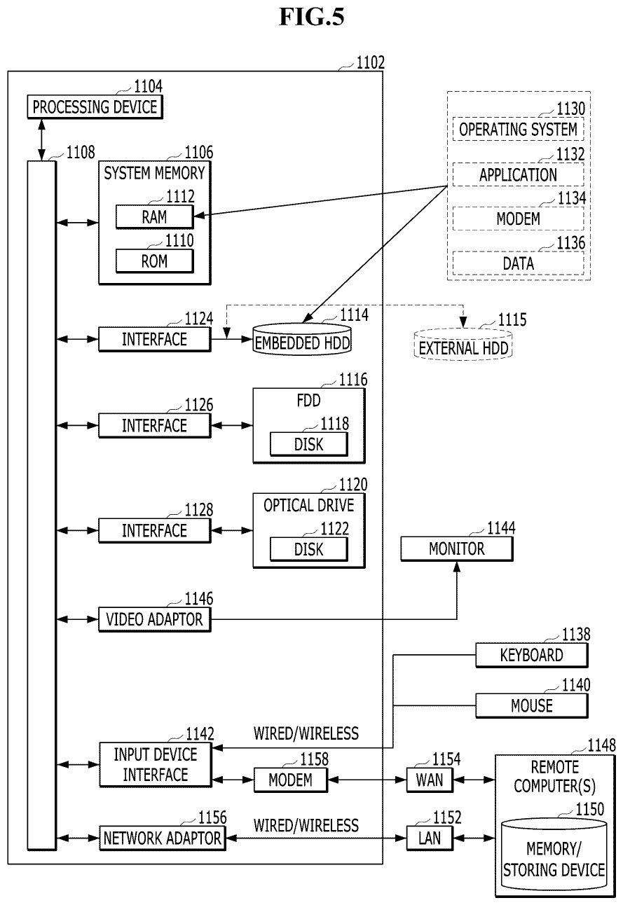

FIG. 5 is a normal schematic diagram of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) or an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the inter compatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for detecting vulnerability in program containing a plurality of source code files, performed by a computing device, comprising:
extracting at least one of a vulnerability file name corresponding to a pre-stored vulnerability file or a vulnerability function name corresponding to a pre-stored vulnerability function, from a description of pre-stored vulnerabilities;
extracting at least one candidate source code file from among the plurality of source code files in the program, the candidate source code file being subject to determination of whether it contains a vulnerability; and
determining at least one of a target file or a target function having a vulnerability within the program, by using the candidate source code file and at least one of the vulnerability file name or the vulnerability function name.

2. The method of claim 1, wherein the extracting at least one of the vulnerability file name or the vulnerability function name comprises: tokenizing a sentence included in the description into a plurality of words and identifying a part of speech of each of the tokenized words to extract at least one noun, thereby determining the noun as the vulnerability file name or the vulnerability function name.

3. The method of claim 2, wherein the determining the noun as the vulnerability file name or the vulnerability function name comprises: determining the noun as the vulnerability file name when the noun includes a predefined first character string, or determining the noun as the vulnerability function name when the noun includes a predefined second character string, wherein the first character string and the second character string are different character strings from each other.

4. The method of claim 1, wherein the determining at least one of the target file or the target function comprises: when the vulnerability function name is not extracted and the vulnerability file name is extracted in the extracting at least one of the vulnerability file name or the vulnerability function name, determining whether at least one candidate source code file is the target file by using the extracted vulnerability file name.

5. The method of claim 4, wherein the determining whether at least one candidate source code file is the target file by using the extracted vulnerability file name comprises:
determining whether the vulnerability file name and a name of the candidate source code file match;
determining the candidate source code file as the target file when the vulnerability file name and the name of the candidate source code file match; and
repeatedly performing the determining at least one of a target file or a target function having a vulnerability within the program, by using the name of the candidate source code file and at least one of the vulnerability file name or the vulnerability function name, when the vulnerability file name and the name of the candidate source code file do not match.

6. The method of claim 1, wherein the determining at least one of the target file or the target function comprises:
determining whether the number of the candidate source code files within the program is one, when the vulnerability function name is not obtained and the vulnerability file name is not obtained;
determining the candidate source code file as the target file, when the number of the candidate source code files is one; and
repeatedly performing the determining at least one of a target file or a target function having a vulnerability within the program, by using a name of the candidate source code file and at least one of the vulnerability file name or the vulnerability function name, when the number of the candidate source code files is not one.

7. The method of claim 1, wherein the determining at least one of a target file or a target function having a vulnerability within the program, by using a name of the candidate source code file and at least one of the vulnerability file name or the vulnerability function name comprises:
determining whether a candidate function is included in the candidate source code file, when the vulnerability function name is obtained; and
determining the target function by using a name of the candidate function, when it is determined that the candidate function is included in the candidate source code file.

8. The method of claim 7, wherein the determining the target function by using the name of the candidate function comprises:
determining whether the vulnerability function name and the name of the candidate function match; and
determining the candidate function as the target function and determining the candidate source code file including the candidate function as the target file, when it is determined that the vulnerability function name and the name of the candidate function match.

9. The method of claim 7, wherein the determining at least one of the target file or the target function comprises:
determining whether the vulnerability function name and the name of the candidate function match; when it is determined that the vulnerability function name and the name of the candidate function do not match,
determining whether the vulnerability file name is obtained, when it is determined that the vulnerability function name and the name of the candidate function do not match; and
determining the target file based on whether the vulnerability file name is obtained, or determining the target file based on the number of the candidate source code files.

10. The method of claim 1, wherein the extracting the at least one candidate source code file comprises: determining whether a candidate function is included in the candidate source code file when the vulnerability function name is obtained, and
the determining at least one of the target file or the target function comprises:
determining whether the vulnerability file name is obtained, when it is determined that the candidate function is not included in the candidate source code file; and
determining the target file based on whether the vulnerability file name is obtained, or determining the target file based on the number of the candidate source code files.

11. The method of claim 1, wherein the candidate source code file is a file including a modified portion within the program.

12. A non-transitory computer readable storage medium including a computer program, wherein the computer program causes a computing device to perform a method for detecting vulnerability in a program containing a plurality of source code files, wherein the method comprises:
extracting at least one of a vulnerability file name corresponding to a pre-stored vulnerability file or a vulnerability function name corresponding to a pre-stored vulnerability function, from a description of pre-stored vulnerabilities;
extracting at least one candidate source code file from among the plurality of source code files in the program, the candidate source code file being subject to determination of whether it contains a vulnerability; and
determining at least one of a target file or a target function having a vulnerability within the program, by using the candidate source code file and at least one of the vulnerability file name or the vulnerability function name.

13. A computing device detecting vulnerability in program containing a plurality of source code files comprising:
at least one processor; and
a memory; and
wherein the at least one processor performs:
extracting at least one of a vulnerability file name corresponding to a pre-stored vulnerability file or a vulnerability function name corresponding to a pre-stored vulnerability function, from a description of pre-stored vulnerabilities;
extracting at least one candidate source code file from among the plurality of source code files in the program, the candidate source code file being subject to determination of whether it contains a vulnerability; and
determining at least one of a target file or a target function having a vulnerability within the program, by using the candidate source code file and at least one of the vulnerability file name or the vulnerability function name.
